(19) United States
(12) Patent Application Publication
(10) Pub. No.: US 2010/0071064 A1
(43) Pub. Date: Mar. 18, 2010

(54) APPARATUS, SYSTEMS, AND METHODS FOR CONTENT SELFSCANNING IN A STORAGE SYSTEM

(76) Inventor: Bret S. Weber, Wichita, KS (US)

Correspondence Address: Duft Bornsen & Fishman LLP, 1526 Spruce Street, Suite 302, Boulder County, CO, 80302, US

(21) Appl. No.: 12/212,365

(22) Filed: Sep. 17, 2008

(51) Int. Cl. G06F 12/14; G06F 12/00

(52) U.S. Cl. 726/24; 711/114; 711/E12.001; 711/E12.091; 707/E17.005

(57) ABSTRACT

Apparatus, systems, and method for content self-scanning within a storage system. Features and aspects hereof operable within a storage controller of a storage system scan blocks of data within the storage system to detect the presence of a pattern in one or more data blocks. The patterns to be matched may be stored as regular expressions in a pattern database in the storage system and may represent, for example, viruses to be detected in the data blocks of the storage system. Data blocks may be scanned, in real time, as they are received from an attached host system. Data blocks may also be retrieved from within the storage system for scanning. The storage system may cooperate with a scanning service computer to determine a file of data blocks related to any data block that matches a portion of a pattern.

### BACKGROUND

1. Field of the Invention

The invention relates generally to content scanning of stored information and more specifically relates to apparatus, systems, and methods for content self-scanning of information stored in a storage system by operation of the storage system.

2. Discussion of Related Art

There are many purposes for scanning the content of data stored on a storage system in a computing environment to detect the presence of particular patterns of data. Such purposes include, but are not limited to: content filtering, regulatory compliance, data mining and reporting, and virus and spam detection. Data mining and report applications may scan the content of stored data to detect certain key data to be extracted for other processing and/or reporting. Regulatory compliance applications may scan data in a storage system to determine whether certain privacy and/or reporting regulations have been complied with. Spam and virus scanning detects the presence of malicious software and/or data stored on a storage system of a computing environment.

Focusing on this last application, for example, as popularity of the Internet and other public networks has grown, it is a continuing challenge to detect and remove malicious elements of data and software from a system to avoid corruption of useful data within the system. Such malicious elements are often referred to as viruses. In like manner, unsolicited and undesired data is often transmitted to computing systems through a user's interaction with the Internet (e.g., through web browsing and email exchanges). Anti-virus and anti-spam scanning software applications are well known to enhance security for most computing systems by detecting and then removing potentially malicious data and/or software.

In general, anti-virus scanning software applications are started on a computer system and instructed to scan all data known to the computer system. Typically such anti-virus scanning software applications scan all files stored on storage systems accessible to the computer system running the antivirus application. The anti-virus application locates each file of related information stored on the storage system and scans the file comparing the file contents to a dictionary or database of patterns of data that represent known viruses (e.g., signatures or patterns that indicate a corresponding virus). In other words, a virus may be detected by locating a signature pattern of data in the contents of a file being scanned.

Such content scanning application, such as anti-virus scanning applications software, generally use regular expression comparison techniques to look for any of the signatures or patterns entered in the database of patterns or signatures of interest (e.g., virus patters or signatures). Regular expression matching techniques find a particular signature or pattern in data being scanned as well as several variations of such a signature or pattern. A signature or pattern to be detected may span any portion of the file contents—a small portion of the file content for a short, simple signature/pattern or a much larger portion of the file content for a lengthy, complex signature/pattern.

Content scanning applications, such as anti-virus scanning applications, utilizing regular expression pattern matching utilize significant computational power of the computing system on which they operate as well as substantial bandwidth in the communication links that couple the computing system to the storage devices or storage subsystem storing the files to be scanned. As the number of signatures/patterns of interest grows and as the complexity of the pattern matching required in detecting such signatures/patterns grows in complexity, the resources consumed on the computing system running the content scanning application also grows. Over-utilization of such resources in a computing system can significantly impact that the overall performance of the computing system as regards the underlying computational purpose of the computing system.

Thus it is an ongoing challenge to reduce the resource utilization on computing systems required for purposes of content scanning to thereby free resources for the underlying computational purpose of the computing system.

### SUMMARY

The present invention solves the above and other problems, thereby advancing the state of the useful arts, by providing apparatus, systems, and methods for content self-scanning the within a storage subsystem utilizing computational resources of the storage subsystem. A content scanning function operable within a storage controller of a storage system scans a block of data stored in the storage system or received from a host system by the storage system. The scanning function uses regular expression matching techniques to scan a block for any of the known signatures/patterns of data indicated in a signature/pattern database. The dictionary or database of such signatures may be stored within the storage system. Upon detection of a matching data block that completely matches the entirety of a pattern or detection of a potentially matching block that partially matches a pattern, the storage controller interacts with a content scanning service operable on a computing system coupled to the storage system to complete the scan of any file related to the matching or potentially matching data block. The regular expression matching performed by the storage controller may be embodied as suitably programmed instructions executed by a processor and/or as regular expression matching assist circuitry. In an exemplary embodiment utilizing a regular expression (block scanning) assist circuit, multiple regular expressions (patterns) may be compared with a data block substantially simultaneously.

In one aspect hereof, a storage system adapted for content self-scanning is provided. The storage system including a plurality of storage devices each device including a plurality of data blocks. The system also includes a pattern database stored on the plurality of storage devices. Each entry of the database corresponds to a content of interest and includes a pattern of data that identifies the corresponding content of interest. The system also includes a storage controller coupled to the plurality of storage devices and adapted to couple to a host system. The storage controller further includes a block scanner adapted to compare the content of a data block to the pattern of data in an entry of the pattern database and a management interface adapted to couple the storage system to a scanning service computer. The block scanner is operable to compare a data block to the pattern of data associated with each entry of the pattern database to determine whether the data block matches a portion of any pattern in the patter database. Responsive to a determination that the data block matches a portion of some pattern, the storage controller is adapted to communicate with the scanning service computer through the management interface to perform a complete scan of a file that contains the data block.

Another aspect hereof provides a method, operable in a storage controller of a storage system, for content scanning data blocks in the storage system. The method includes comparing a data block to a pattern associated with each entry in a pattern database stored in the storage system. Responsive to the data block matching a portion of a pattern in any entry of the pattern database, the method then communicates with a scanning service computer to perform a complete scan of a file that contains the data block.

Still another aspect hereof provides a method, operable in a storage controller of a storage system, for content scanning data blocks in the storage system. The method includes sensing a signal to commence a scan of a plurality of data blocks. Responsive to sensing the signal, the method then performs a scan by steps including comparing each of the plurality of data blocks to a pattern in each of a plurality of entries in a pattern database stored in the storage system. Responsive to a data block matching a portion of a pattern, the method then reports a possible match for the data block to a scanning service computer coupled to the storage controller. The method then receives, from the scanning service computer, a list of logical block addresses that identify a sequence of data blocks related to the data block that matched the portion of a pattern. The method then compares the sequence of data blocks to the pattern and reports to the scanning service computer whether the entire pattern matches any portion of the sequence of data blocks.

### BRIEF DESCRIPTION OF THE DRAWINGS

FIG. 1 is a block diagram of an exemplary storage system enhanced in accordance with features and aspects hereof to provide content self-scanning capabilities.

FIGS. 2 and 3 are block diagrams of exemplary storage controller functions of an enhanced storage system as in FIG. 1 to provide content self-scanning in accordance with features and aspects hereof.

FIG. 4 is a block diagram of an exemplary storage controller architecture of an enhanced storage system as in FIG. 1 to provide content self-scanning in accordance with features and aspects hereof.

FIGS. 5 through 8 are flowcharts describing exemplary methods for content self-scanning within a storage system in accordance with features and aspects hereof.

### DETAILED DESCRIPTION OF THE DRAWINGS

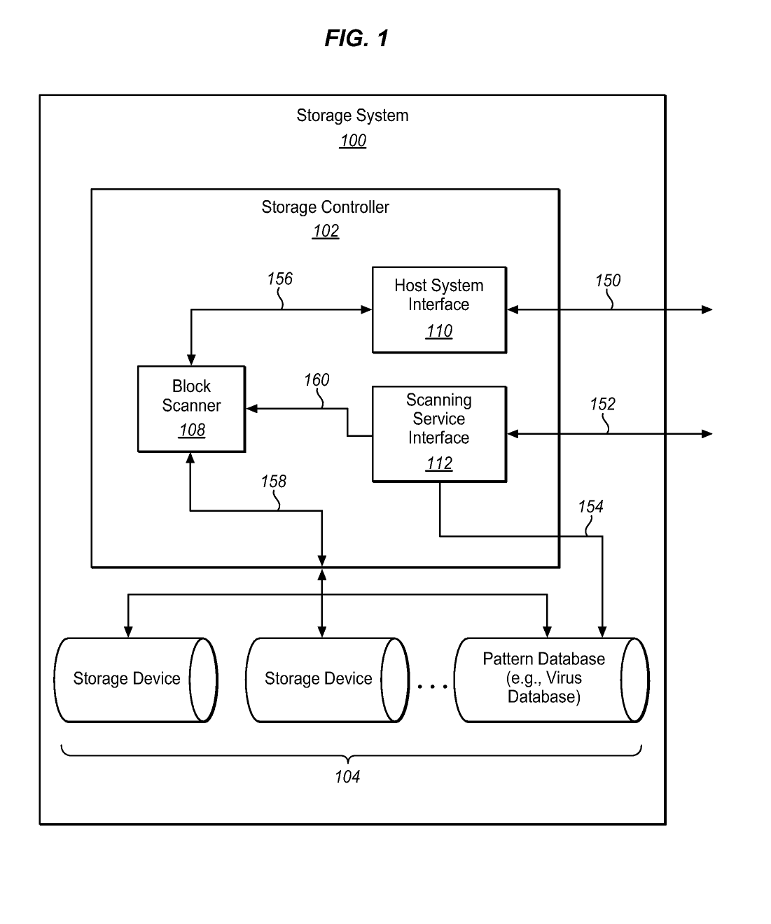

FIG. 1 is a block diagram of a storage system 100 enhanced in accordance with features and aspects hereof to provide content self-scanning of data blocks in the storage system 100. System 100 includes storage controller 102 coupled to a plurality of storage devices 104. A pattern database 106 may be stored in the storage devices 104 or in other suitable memory associated with storage controller 102. Block scanner 108 is operable within storage controller 102 to scan data blocks presently stored, or to be stored, in storage devices 104. In particular, block scanner 108 is operable to compare a data block to each a pattern associated with each entry in the pattern database 106. Each pattern may represent a regular expression to be utilized in searching a data block to determine whether the pattern represented by the regular expression is present in the data block being compared to the pattern. In one exemplary embodiment, each entry of the pattern database includes a pattern (e.g., regular expression) that represents a computer virus. Thus, storage system 100 has the ability to self-scan data blocks associated with the storage system 100 to effectuate a virus scan of such data blocks. As noted above, system 100 is more generally applicable to any form of content scanning including, for example, anti-virus scanning, anti-spam scanning, content filtering, data mining, regulatory compliance, and data reporting. Thus, anti-virus scanning as discussed further herein below is intended merely as one exemplary application of the more generalized features and aspects hereof that provide content scanning of data blocks in a storage system.

Storage controller 102 may also include host interface 110 adapted for coupling storage system 100 to one or more host systems (not shown) that generate I/O requests to be processed by storage system 100. Data blocks may be received via path 150 through host interface 110 (e.g., data blocks of an I/O write request) and passed via path 156 to block scanner 108. Block scanner 108 then scans the data block to determine if a portion of the data block matches a portion of any of the patterns in the pattern database 106. Data blocks may then be applied to the storage devices 104 by block scanner 108 via path 158.

Storage controller 102 may also include scanning service interface 112 adapted to receive the content of the pattern database 106 from a scanning service computer coupled via path 152. The received pattern database content may then be stored in the pattern database 106 by scanning service interface 112 via path 154. Updates to the pattern database 106 may also be received via the scanning service interface 112. A scanning service computer may also direct the operation of block scanner 108 via path 160. A scanning service computer may also serve to cooperate with the enhanced storage system 100 to complete the content scanning operations of the enhanced or system 100 as discussed further herein below.

Any pattern may be completely contained in any single data block or may span one or more logically sequential data blocks (regardless of whether the data blocks are physically sequential on the storage devices). The sequence of data blocks that comprise a file managed by the file and operating systems of attached computer systems may not be physically stored as contiguous data blocks on the storage system 100. Storage system 100 generally has no information to map particular data blocks to the logical, higher level concept of a file that includes multiple data blocks. Rather, attached host systems may intentionally or unavoidably distribute multiple data blocks of a file essentially randomly throughout the available logical block addresses of the storage system. Thus, only filesystem and operating system programs in attached computers (i.e., not the storage system) have information relating to the mapping of particular files to particular sequences of logical blocks. When block scanner 108 detects a possible (full or partial) match of a data block with one or more patterns, it communicates the identity of the possible matching data block to the scanning service computer via interface 112. The scanning service computer may then identify what file (represented as a sequence of logical block addresses) contains the data block that may match a pattern.

In one exemplary embodiment, the scanning service computer may then itself complete the scan of the identified file that may match one or more patterns. In such a case, the scanning service computer uses its own copy of a pattern database and simply reads the file contents in order to detect the presence of a matching pattern. Since the storage system 100 performs the initial scan to recognize a possible match, the scanning service computer is not burdened with performing a complete scan of every file known to it. Rather, the storage system 100 identifies a possible match of a pattern in a data block and the scanning service computer need only process a scan for the file that contains the identified possible matching data block.

In another exemplary embodiment, after the scanning service computer identifies the file that includes the possibly matching data block, it returns a list of logical block addresses of the entire file to the storage system 100. The list defines a sequence of logical block addresses that form the content of the file containing the possibly matching data block. The block scanner 108 then scans each block identified in the list (translating the logical block addresses to physical data block locations as needed), in the sequence provided by the list, to determine if any pattern in the pattern database 106 is found in the entire file. The storage system 100 then returns the result of the scan to the scanning service computer to allow it to take any required remedial actions or further processing depending on the results of the scan completed by the system 100.

As noted above, storage controller 102 may initiate a scan of data blocks as they are received from an attached host system in an I/O request (e.g., an I/O write request). In addition or in the alternative, as discussed further herein below, storage controller 102 may initiate scanning of blocks previously stored on storage devices 104. For example, an attached host system coupled through host system interface 110 or a scanning service computer coupled through scanning service interface 112 may direct the storage system 102 to commence a scan of all blocks previously stored in storage devices 104. Still further, storage controller 102 may also detect an idle period during which storage controller 102 is not presently occupied processing I/O requests received via path 150 from an attached host through host system interface 110. Responsive to detecting such an idle period, storage controller 102 may initiate a background scan of all blocks stored on the storage devices 104 of system 100. Still further, the background scan of all blocks may be performed in conjunction with other background processing within the storage controller to access all blocks. For example, it is common in RAID storage controllers that the controller may from time to time “scrub” all blocks to verify integrity of the data (i.e., to verify the redundancy data of each stripe and/or the mirrored redundancy data in a mirrored RAID volume. By combining the background content scan with other background read processing directed to all blocks of a storage system, the background content scan need not add any overhead storage bandwidth utilization over that already required for normal operation with scrubbing performed from time to time.

As shown in FIG. 1, storage controller 102 includes both a host system interface 110 and a scanning service interface 112. In the one exemplary embodiment, the two interfaces may represent distinct components utilizing distinct communication paths and/or protocols. For example, the host system interface may utilize Fibre Channel, SAS, or SATA communication protocols and media as are common for storage system coupling whereas the scanning service interface 112 may utilize Ethernet or other standard networking connections. In like manner, the scanning service interface 112 as a distinct interface may couple to a distinct scanning service computer whereas the host system interface 110 couples to one or more client host systems running application and operating system software utilizing the features of storage system 100.

In another exemplary embodiment, the host system interface 110 and scanning service interface 112 may utilize a common communication media but may logically separate the communications utilized by host systems requesting I/O operations and content scanning services utilized to complete scanning operations as discussed above. For example, the host system generated I/O requests may utilize standard storage related command and status exchanges (e.g., SCSI read/write commands and status) whereas messages relating to interaction between the block scanner 108 and a scanning service computer was may utilize vendor unique command and status exchanges over the same communication media. Or, for example, communications between block scanner 108 and a scanning service computer may utilize out of band communications over the same communication medium. Still further, the scanning service computer may be any host system adapted to provide the desired communications with the block scanner of the enhanced storage system 100.

FIG. 1 is intended to detect the principle functional modules and elements within storage controller 102 of the enhanced storage system 100 related to features and aspects hereof. Numerous additional and equivalent elements within a fully functional storage system 100 will be readily apparent to those of ordinary skill in the art and are omitted for simplicity and brevity of this discussion

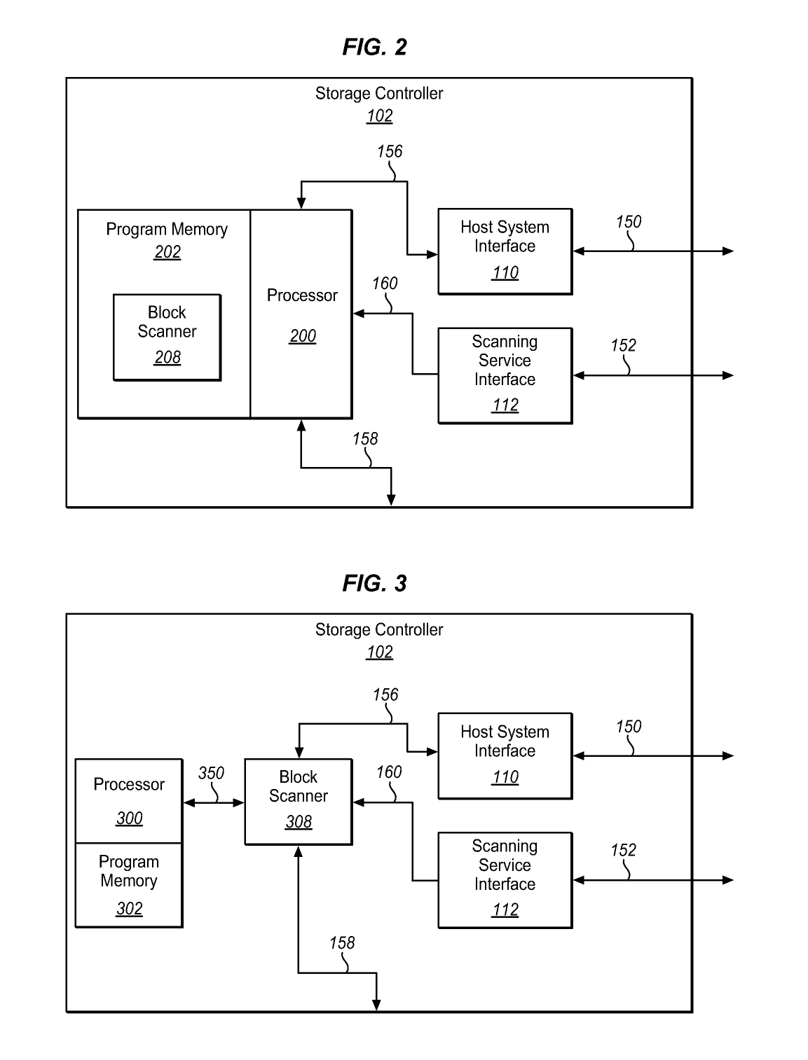

FIG. 2 is a block diagram of an exemplary embodiment of features and aspects hereof for a storage controller 102 operable in an enhanced storage system 100 of FIG. 1. Storage controller 102 of FIG. 2 depicts block scanner 208 implemented as suitably programmed instructions stored in a program memory 202 for execution by processor 200. Such a software/firmware implementation of block scanner 208 provides simplicity to maintain a lower cost solution for the self-scanning features of the enhanced storage system. FIG. 3 is a block diagram of another exemplary embodiment of features and aspects hereof for a storage controller 102 operable in an enhanced storage system. Storage controller 102 of FIG. 3 depicts block scanner 308 as an integrated circuit component dedicated to the functions of scanning blocks for patterns representing content of interest. For example, block scanner circuit 308 may be a circuit used for regular expression scanning such as the Tarari family of integrated circuits available from LSI Corporation (www.lsi.com). The Tarari T1000, T9000, and T10 integrated circuits are exemplary of specialized circuits adapted for high speed regular expression matching. Through appropriate bus interface logic (not shown in FIG. 3 but generally known to those of ordinary skill in the art) the block scanner circuit 308 is coupled directly to the host system interface 110 via path 156, coupled to the service scanning service interface 112 via path 160, coupled to storage devices via path 158, and coupled to processor bus 350. The block scanner circuit 308 may thus interact with processor 300 running programs stored in program memory 302. The block scanner circuit implementation of FIG. 3 provides higher performance pattern matching to implement the content self-scanning features and aspects hereof.

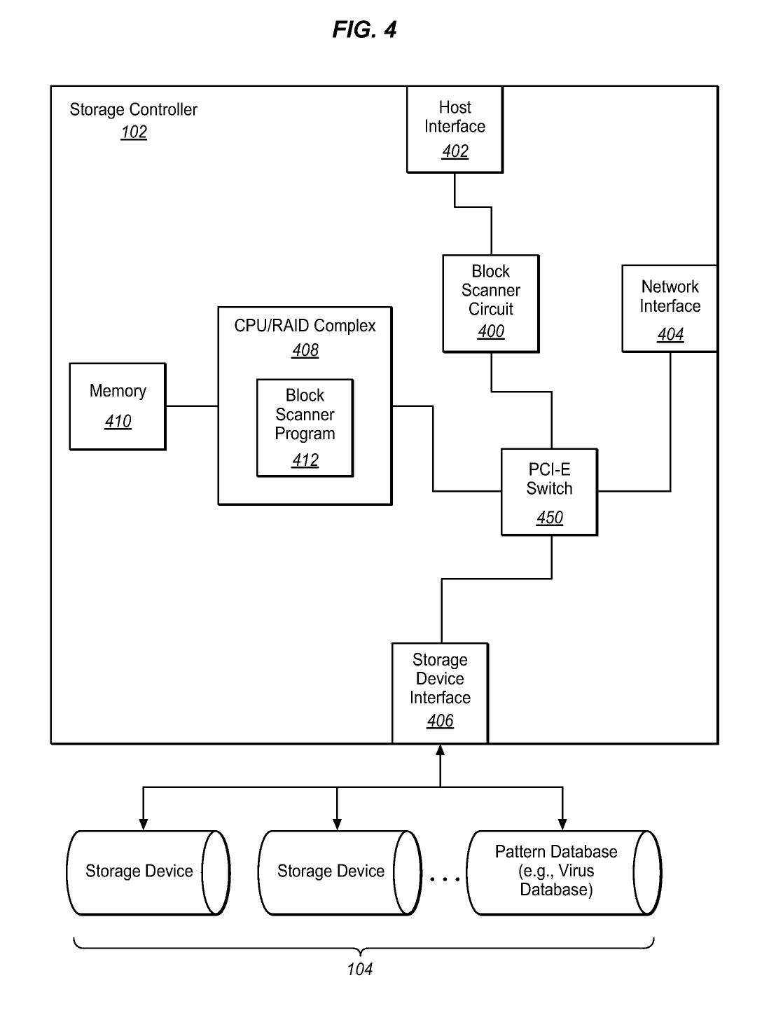

FIG. 4 is a block diagram describing yet another exemplary embodiment of a storage controller 102 operable in an enhanced storage system 100 of FIG. 1. Storage controller 102 of FIG. 4 represents one exemplary embodiment of circuits in an exemplary, operational storage controller 102. Block scanner circuit 400 is coupled in-line directly to host interface 402 to permit scanning of blocks data blocks as they are received from an attached host system (e.g., received in an I/O write request). Host interface 402 may provide any of several well-known couplings of storage controller 102 to attached host systems including, for example, Fibre Channel, SAS, parallel SCSI, parallel ATA, serial ATA, etc. CPU/RAID complex 408 represents a processor complex and associated RAID management logic and assist circuitry for controlling operation of RAID logical volumes managed by storage controller 102. Block scanner program 412 represents suitably programmed instructions executing within CPU/RAID complex 408 for purposes of scanning the content of data blocks previously stored on storage devices of the enhanced storage system. Memory 410 is coupled to CPU/RAID complex 408 for storing data and programmed instructions used in the operation of CPU/RAID complex 408. Network interface 404 provides a standard interface for coupling the storage controller to host computer systems and/or management computer systems such as a scanning service computer. Network interface 404 may provide any of several well-known couplings of storage controller 102 including, for example, Internet (Ethernet), Fibre Channel, etc. Storage device interface 406 couples storage controller 102 to the storage devices 104 within the storage system. In particular, pattern database 106 may be stored in storage devices 104 coupled to the storage controller 102 via storage device interface 406. Storage device interface 406 may provide any of several well-known interfaces including, for example, SAS, serial ATA, parallel SCSI, parallel ATA, Fibre Channel, etc.

Components of storage controller 102 are coupled through a peripheral interface bus such as the standardized Peripheral Computer Interconnect (PCI) bus. For example, PCI Express (PCI-E.) may be used for simple, cost effective, high speed coupling of components within storage controller 102. PCI-E. switch 450 provides such an exemplary coupling of the various devices within storage controller 102

Those of ordinary skill in the art will readily recognize numerous additional and equivalent configurations and components for the storage controller embodiments depicted in FIGS. 2 through 4. Such additional and equivalent configurations and components are omitted herein for simplicity and brevity of this discussion. FIGS. 2 through 4 are therefore intended merely as exemplary embodiments of features and aspects hereof.

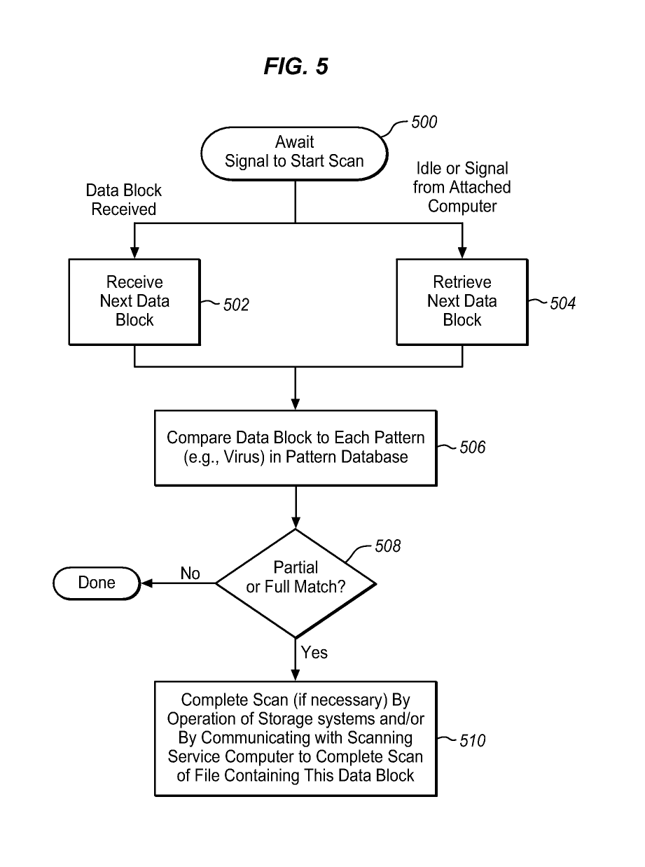

FIG. 5 is a flowchart describing an exemplary method in accordance with features and aspects hereof to provide content self-scanning within a storage system. As noted above, content may be scanned by the storage system as it is received from attached host systems (e.g., during receipt of data corresponding to an I/O write request). The method of FIG. 5 may be initiated or commenced in response to any of several signals or events. For example, if scanning of received data blocks from an attached host system is enabled in the storage system, receipt of a next data block may represent such a signal or event to initiate or commence content scanning of the received data block. Still further, as discussed further herein below, an attached host system or scanning service computer may transmit an appropriate message or signal to the storage system requesting that the storage system initiate background scanning of data blocks previously stored in the storage devices of the storage system. In like manner, the storage system may monitor performance of the storage system in processing of received I/O requests. Where the resource utilization of the storage system for processing received I/O requests is low off for a period of time such that the storage controller of the storage system is substantially idle (e.g. not presently processing I/O request), the storage controller may generate its own signal or event to initiate or commence background content scanning of data blocks previously stored in the storage system.

Step 500 awaits receipt of a signal or event signifying that content scanning of one or more data blocks should be initiated. Step 502 is performed if the initiating signal indicates that a data block from an attached host system is received and needs to be scanned for content of interest. Step 504 is performed if the signal received indicates that the storage system should commence scanning of one or more data blocks previously stored in the storage system. Regardless of the reason for initiating the scan, step 506 compares the next data block to be scanned to each pattern stored in entries of the pattern database. Step 508 then determines whether the comparison of step 506 detected no match, detected a match of the entire data block with one or more patterns, or detected a partial match of the data block with one or more patterns. If the data block does not match any of the patterns fully or partially, the method is complete for this block and may be repeated for additional received and/or retrieved data blocks to continue the scan.

If this data block partially or fully matched one or more patterns as determined by the comparison of step 506, step 510 completes the scan of a file containing this data block. Where a data block fully matches a pattern, there may be no need for additional scanning. In other words, the scan may be completed by a single block matching a pattern. For example, where the data block content pattern matching is applied to detect the presence of a computer virus, a fully matching data block may contain the entire virus. Also as discussed above, completion of the scan for a file containing the potentially matching data block may be performed cooperatively between the enhanced storage system and an attached scanning service computer. For example, the scanning service computer may simply read the file containing the potentially matching block and do its own content scan to determine whether the file includes any of the patterns in a pattern database. Or, for example, if a single data block completely matched the pattern, the scanning service computer may simply identify the file containing the matching data block and proceed with knowledge that an identified pattern has been detected in the identified file.

Alternatively, for example, the scanning service computer may determine the sequence of blocks for the file containing the potentially matching data block and supply a list of such blocks in sequential order for use by the enhanced storage system to complete the scan for a sequence of blocks representing the contiguous data of the file containing the potentially matching block.

Still further, in other exemplary embodiments, the storage system may include knowledge of the file system used by attached host systems for storage of information in files. The storage system may then determine what file contains the matching data block and thus determine its own list of related data blocks to be scanned to complete the scan.

The method of FIG. 5 then completes with respect to the current block being scanned and may be repeated for additional blocks to be scanned within the storage system.

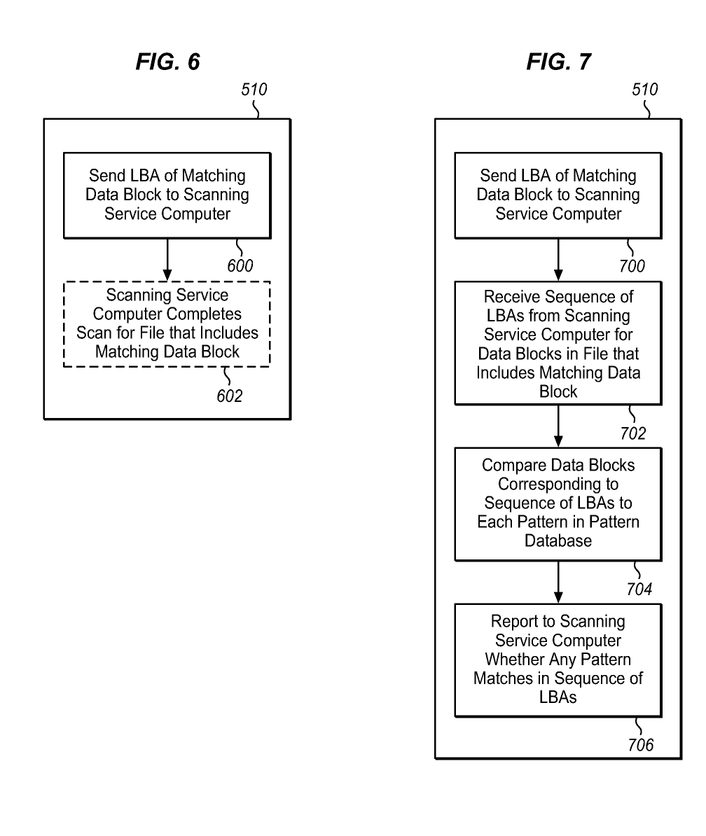

FIG. 6 is a flowchart describing exemplary additional details of the processing of step 510 of FIG. 5 to complete the scan of a file that includes a potentially matching data block. In step 600, the enhanced storage system sends the logical block address of the potentially matching data block to the scanning service computer. In step 602, the scanning service computer completes the scan for the file that includes the potentially matching data block. Where a data block fully matches a pattern, the scan may be completed already such that the scanning service computer need not scan other blocks to complete the scan for the matching pattern. Processing of step 602 would typically be performed within the scanning service computer coupled to the enhanced storage system (as signified by the dashed line of step 602). In addition, step 602 represents any desired processing for the file when a match of any of the patterns is detected. For example, where the patterns each represent a potential virus, step 602 represents desired processing to remediate the virus by isolating it, deleting it, or otherwise removing the virus from the data blocks stored in the storage system.

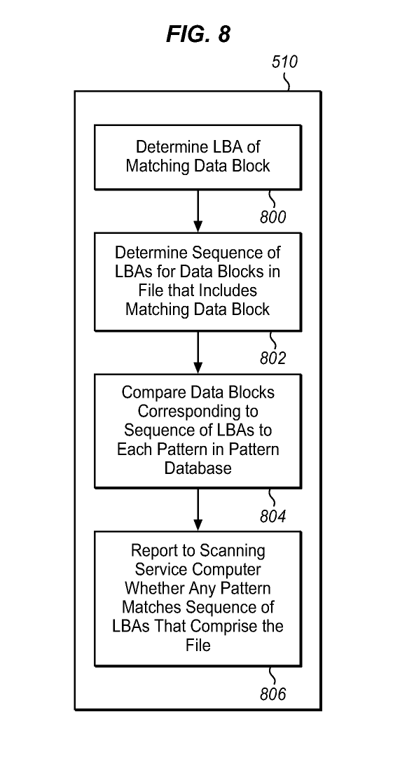

FIG. 7 is a flowchart describing other exemplary additional details of the processing of step 510 of FIG. 5 to complete the scan of a file that includes a potentially matching data block. In step 700, the enhanced storage system sends the logical block address of the potentially matching data block to the scanning service computer. At step 702 the enhanced storage system receives from the scanning service computer a sequence of logical block addresses representing data blocks in the file that includes the potentially matching data block. At step 704 the enhanced storage system compares the sequence of data blocks corresponding to the list of logical block addresses with each pattern in the pattern database. In this comparison, the pattern is searched for across all the sequence of data blocks as though they represent a contiguous sequence of stored information. Step 706 then returns a report from the enhanced storage system to the scanning service computer indicating the result of the comparison in step 704. This result indicates whether any of the patterns in the pattern database match the sequence of data blocks specified by the list of logical block the addresses. The report may include the particular pattern or patterns that were found in the sequence of data blocks. The scanning service computer then may take appropriate action to further process the file based on whether any pattern was found in the sequence of data blocks. For example, where the patterns each represent a potential virus in a computer system, the scanning service computer may take appropriate actions to remediate the detected virus.

FIG. 8 is a flowchart describing other exemplary additional details of the processing of step 510 of FIG. 5 to complete the scan of a file that includes a potentially matching data block. In the method of FIG. 8, the storage controller is presumed to include knowledge of the file system structures used by attached host systems to store information on the storage devices. Thus, the storage controller of the storage system may determine the file that contains the potentially matching data block and may then complete the scan without need for communicating with the scanning service computer.

In step 800, the enhanced storage system determines the logical block address of the potentially matching data block. At step 802 the enhanced storage system, possessed with knowledge of the file system layout and structures in use by attached host systems, determines a sequence of logical block addresses representing data blocks in the file that includes the potentially matching data block. At step 804 the enhanced storage system compares the sequence of data blocks corresponding to the list of logical block addresses with each pattern in the pattern database. In this comparison, the pattern is searched for across all the sequence of data blocks as though they represent a contiguous sequence of stored information. Step 806 then returns a report from the enhanced storage system to the scanning service computer indicating the result of the comparison in step 804. This result indicates whether any of the patterns in the pattern database match the sequence of data blocks of the file that contains the first matching data block. The report may include the particular pattern or patterns that were found in the sequence of data blocks and the file that contains the sequence of data blocks. The scanning service computer then may take appropriate action to further process the file based on whether any pattern was found in the sequence of data blocks. For example, where the patterns each represent a potential virus in a computer system, the scanning service computer may take appropriate actions to remediate the detected virus.

The methods of FIGS. 5 through 8 are generally operable within the storage system and thus relieve the burden of content scanning from any attached computer systems. Rather, processing power within the storage system serves to scan data blocks received by the storage system from an attached host system and/or to scan data blocks previously stored in the storage system.

Those of ordinary skill in the art will readily recognize various additional and equivalent method steps in implementing the methods of FIGS. 5 through 8. Such additional and equivalent method steps are omitted herein for simplicity and brevity of this discussion.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A storage system adapted for content self-scanning, the storage system comprising:
a plurality of storage devices each device including a plurality of data blocks;
a pattern database stored on the plurality of storage devices wherein each entry of the database corresponds to a content of interest and includes a pattern of data that identifies the corresponding content of interest; and
a storage controller coupled to the plurality of storage devices and adapted to couple to a host system,
the storage controller further comprising:
a block scanner adapted to compare the content of a data block to the pattern of data in an entry of the pattern database; and
a management interface adapted to couple the storage system to a scanning service computer,
wherein the block scanner is operable to compare a data block to the pattern of data associated with each entry of the pattern database to determine whether the data block matches a portion of any pattern in the patter database, and
wherein, responsive to a determination that the data block matches a portion of some pattern, the storage controller is adapted to communicate with the scanning service computer through the management interface to perform a complete scan of a file that contains the data block.

2. The system of claim 1
wherein the storage controller further comprises:
a processor for executing programmed instructions, and
wherein the block scanner further comprises:
a memory coupled to the processor and storing programmed instructions that, when executed by the processor, compare the content of the data block to the pattern of data.

3. The system of claim 1
wherein the block scanner further comprises:
a regular expression processor circuit adapted to receive the data block and adapted to access the pattern database and adapted to compare the content of the data block to the pattern of data.

4. The system of claim 1
wherein the block scanner is operable during periods of time in which the storage controller is not processing I/O requests received from an attached host system, and
wherein the block scanner is operable to access the data block to be compared from the plurality of storage devices.

5. The system of claim 4
wherein the storage system is a RAID storage system, and
wherein the periods of time are periods of time in which the storage system is scrubbing redundancy information managed by the RAID storage system.

6. The system of claim 1
wherein the block scanner is operable to compare the data block with the pattern as the data block is received from an attached host computer.

7. The system of claim 1
wherein the block scanner is operable to communicate, via the management interface to the scanning service computer, a logical block address of the data block responsive to determining that the data block matches a portion of some pattern,
wherein the block scanner is adapted to receive, via the management interface from the scanning service computer, a list of logical block addresses that comprise a file containing the logical block address communicated to the scanning service computer,
wherein the block scanner is operable to compare all data blocks identified in the list of logical block addresses in the order specified by the list to the pattern of data associated with each entry of the pattern database to determine whether the sequence of data blocks matches the entirety of any pattern in the pattern database, and
wherein the block scanner is operable to communicate via the management interface to the scanning service computer whether the sequence of data blocks matches any pattern in the pattern database.

8. The system of claim 1
wherein the pattern database further comprises:
a virus pattern database wherein each pattern in the virus pattern database corresponds to a virus.

9. The system of claim 1
wherein the block scanner is operable in response to a communication received via the management interface from the scanning service computer to commence scanning operation.

10. The system of claim 1
wherein the management interface is further adapted to couple the storage controller with an attached host system to receive and process I/O requests to the storage system.

11. The system of claim 1
wherein the storage controller further comprises:
a host system interface adapted to couple the storage controller to an attached host system to receive and process I/O requests to the storage system.

12. A method, operable in a storage controller of a storage system, for content scanning data blocks in the storage system, the method comprising:
comparing a data block to a pattern associated with each entry in a pattern database stored in the storage system;
responsive to the data block matching a portion of a pattern in any entry of the pattern database, completing a scan of a file that contains the data block.

13. The method of claim 12 further comprising:
receiving the data block to be compared from an attached host system,
wherein the step of comparing is performed as the data block is received from the attached host system.

14. The method of claim 12 further comprising:
retrieving the data block from storage devices of the storage system prior to comparing the data block.

15. The method of claim 12 further comprising:
awaiting direction from an attached computer system to commence the step of comparing.

16. The method of claim 12
wherein the storage controller is adapted to process I/O requests received from an attached host system,
the method further comprising:
detecting an idle period of time in which the storage controller is not presently processing I/O requests; and
performing the step of comparing responsive to detection of the idle period of time.

17. The method of claim 12
wherein the step of completing further comprises:
determining the file by operation of the storage system having knowledge of the file system used by attached host systems.

18. The method of claim 12
wherein the step of completing further comprises:
communicating with a scanning service computer to complete the scan of the file.

19. The method of claim 18
wherein the step of communicating further comprises:
communicating a logical block address of the data block to the scanning service computer;
receiving a list of logical block addresses for a sequence of data blocks of a file that includes the data block;
comparing the sequence of data blocks to the pattern associated with each entry in the pattern database; and
communicating to the scanning service computer whether any pattern in the pattern database is found in the sequence of data blocks.

20. The method of claim 18
wherein the step of communicating further comprises:
communicating a logical block address of the data block to the scanning service computer wherein the scanning service computer completes the scan of the file that includes the data block.

21. A method, operable in a storage controller of a storage system, for content scanning data blocks in the storage system, the method comprising:
sensing a signal to commence a scan of a plurality of data blocks;
responsive to sensing the signal, performing the scan further comprising the steps of:
comparing each of the plurality of data blocks to a pattern in each of a plurality of entries in a pattern database stored in the storage system;
responsive to a data block matching a portion of a pattern, performing the steps of:
reporting a possible match for the data block to a scanning service computer coupled to the storage controller;
receiving, from the scanning service computer, a list of logical block addresses that identify a sequence of data blocks related to the data block that matched the portion of a pattern;
comparing the sequence of data blocks to the pattern; and
reporting to the scanning service computer whether the entire pattern matches any portion of the sequence of data blocks.

22. The method of claim 21
wherein the storage controller is adapted to process I/O requests from an attached host system,
the method further comprising:
detecting an idle period in which the storage controller is not presently processing I/O requests; and
generating the signal to commence a scan responsive to detection of the idle period.

23. The method of claim 21 further comprising:
receiving the signal to commence scan from the scanning service computer.

24. The method of claim 21
wherein the pattern in each entry of the pattern database represents a virus, and
wherein the steps to perform a scan are adapted to detect a virus in data blocks of the storage system.
